(19) United States
(12) Patent Application Publication
(10) Pub. No.: US 2008/0199617 A1
(43) Pub. Date: Aug. 21, 2008

(54) SUBSTRATE PROCESSING METHOD, SUBSTRATE PROCESSING SYSTEM, AND STORAGE MEDIUM

(75) Inventors: Yuichiro Inatomi, Nirasaki-shi (JP); Mitsuaki Iwashita, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/031,101

(22) Filed: Feb. 14, 2008

(30) Foreign Application Priority Data
Feb. 19, 2007 (JP) 2007-038272

(51) Int. Cl. B05D 1/32; B05B 7/00

(52) U.S. Cl. 427/282; 118/300

(57) ABSTRACT

In the present invention, a resist pattern size shrink liquid is applied onto a resist pattern of the substrate. The substrate is then heated, whereby a lower layer portion of the resist pattern size shrink liquid in contact with the front surface of the resist pattern is changed in quality to insoluble to pure water. An upper layer portion of the resist pattern size shrink liquid is then removed with the removing solution. In this removing step, a solution film of pure water is first formed on the substrate with the substrate at rest to dissolve the upper layer portion of the resist pattern size shrink liquid by the solution film of pure water. Pure water is then supplied to the substrate with the substrate being rotated to remove the upper layer portion of the resist pattern size shrink liquid from a top of the substrate. The substrate is then rotated to be dried.

### BACKGROUND OF THE INVENTION

1. Field of the Invention

The present invention relates to a substrate processing method for shrinking the size of a resist pattern formed on a substrate, a substrate processing system, and a storage medium storing a program for causing a computer to embody the substrate processing method.

2. Description of the Related Art

In photolithography process in a process of manufacturing semiconductor devices, for example, processing of forming a resist film on a wafer, exposing the resist film to light, and developing it to form a resist pattern on the wafer.

For formation of the resist pattern, miniaturization of the resist pattern is required in order for higher integration of the semiconductor devices, and in response to that, wavelength of an exposure light source is increasingly reduced. However, there are technical and cost limits to the reduction of the wavelength of the exposure light source at present. Hence, RELACS (Resolution Enhancement Lithography Assisted by Chemical Shrink) technology is proposed in which a film layer of a resist pattern size shrink liquid is formed on inner wall surfaces of holes and grooves of the resist pattern to shrink the size of the hole diameter, the line width, or the like of the resist pattern (Japanese Patent Application Laid-open No. 2003-234279).

In this RELACS technology, a water-soluble resist pattern size shrink liquid (RELACS agent) is first applied on a resist pattern on the wafer front surface. A lower layer portion of the resist pattern size shrink liquid in contact with the inner wall surfaces of the holes and grooves of the resist pattern is then changed in quality to insoluble, for example, by heat. An upper layer portion of the water-soluble resist pattern size shrink liquid is removed with pure water to thereby shrink the size of the resist pattern.

However, as described above in the RELACS technology, a step of removing the upper layer portion of the excessive resist pattern size shrink liquid at last is typically performed by rotating the wafer and supplying high flow of pure water to the front surface of the rotated wafer. When a large amount of pure water is supplied to the rotated wafer to remove the excessive resist pattern size shrink liquid as described above, many defects have appeared on the front surface of the finally formed resist pattern in some cases. One of the reasons of the above is that the resist pattern size shrink liquid of the lower layer portion to be left is damaged due to the shock to the wafer by the pure water at the supply of the pure water. Occurrence of many defects on the front surface of the resist pattern inhibits a circuit pattern with an appropriate size from being finally formed.

### SUMMARY OF THE INVENTION

An object of the present invention is to reduce defects occurring on a front surface of a final resist pattern when shrinking the size of the resist pattern using the RELACS technology.

The present invention to attain the above object is a substrate processing method for shrinking a size of a resist pattern formed on a substrate, including: a coating step of applying a resist pattern size shrink liquid soluble to a removing solution onto the resist pattern of the substrate; thereafter, a quality-changing step of changing in quality a lower layer portion of the resist pattern size shrink liquid in contact with a front surface of the resist pattern to insoluble to the removing solution; and thereafter, a removing step of removing an upper layer portion which has not changed in quality of the resist pattern size shrink liquid with the removing solution. Further, the removing step includes: a first step of forming a solution film of a removing solution on the substrate with the substrate at rest to dissolve the upper layer portion of the resist pattern size shrink liquid by the solution film of the removing solution; thereafter, a second step of supplying a removing solution to the substrate with the substrate being rotated to remove the upper layer portion of the resist pattern size shrink liquid from a top of the substrate; and thereafter, a third step of drying the substrate.

According to the present invention, in the removing step of the upper layer portion of the resist pattern size shrink liquid, a solution film of the removing solution on the substrate is first formed with the substrate at rest to dissolve the upper layer portion of the resist pattern size shrink liquid by the solution film of the removing solution, so that the shock to the substrate by the removing solution at the supply of the removing solution can be lessened. As a result of this, the damage to the lower portion of the resist pattern size shrink liquid can be reduced to reduce defects on the front surface of a resist pattern to be finally formed.

The first step may be performed by a solution film forming nozzle, which has a discharge port equal to or longer than a diameter of the substrate, moving from above one end portion of the substrate to above another end portion while discharging the removing solution. This can further lessen the shock to the substrate by the removing solution at the supply of the removing solution.

The second step may be performed by a cleaning nozzle, which has a discharge port equal to or longer than a diameter of the substrate, being located above the diameter of the rotated substrate and discharging the removing solution onto the diameter of the substrate. This can lessen the shock to the substrate by the removing solution also in the second step to thereby further reduce the defects on the resist pattern to be finally formed.

The present invention according to another aspect is a substrate processing system for shrinking a size of a resist pattern formed on a substrate, including: a coating unit applying a resist pattern size shrink liquid soluble to a removing solution onto the resist pattern of the substrate; a quality-changing unit changing in quality a lower layer portion of the resist pattern size shrink liquid in contact with a front surface of the resist pattern to insoluble to the removing solution; and a removing unit removing an upper layer portion which has not changed in quality of the resist pattern size shrink liquid with the removing solution. Further, the removing unit includes: a rotary holding member capable of holding and rotating the substrate; a solution film forming nozzle supplying a removing solution onto the substrate at rest to form a solution film of the removing solution on the substrate to thereby dissolve the upper layer portion of the resist pattern size shrink liquid by the solution film of the removing solution; and a cleaning nozzle supplying a removing solution onto the rotated substrate to remove the upper layer portion of the resist pattern size shrink liquid on the substrate from a top of the substrate.

The present invention according to another aspect is a computer-readable storage medium storing a program running on a computer of a control unit controlling a substrate processing system to execute the above-described substrate processing method by the substrate processing system.

According to the present invention, defects on a resist pattern when shrinking the size of the resist pattern using the RELACS technology can be reduced to improve yields.

### BRIEF DESCRIPTION OF THE DRAWINGS

FIG. 1 is a plan view showing the outline of a configuration of a substrate processing system;

FIG. 2 is a front view of the substrate processing system in FIG. 1;

FIG. 3 is a rear view of the substrate processing system in FIG. 1;

FIG. 4 is an explanatory view of a longitudinal section showing the outline of a configuration of a coating unit;

FIG. 5 is an explanatory view of a transverse section showing the outline of a configuration of the coating unit;

FIG. 6 is an explanatory view of a longitudinal section showing the outline of a configuration of a removing unit;

FIG. 7 is an explanatory view of a transverse section showing the outline of a configuration of the removing unit;

FIG. 8 is a perspective view of a solution film forming nozzle;

FIG. 9 is an explanatory view of a longitudinal section showing the outline of a configuration of a heating unit;

FIG. 10 is a flowchart showing main steps of wafer processing;

FIG. 11 is an enlarged longitudinal sectional view of a wafer on which a resist pattern size shrink liquid is applied;

FIG. 12 is an enlarged longitudinal sectional view of a wafer showing a state in which a lower layer portion of the resist pattern size shrink liquid has changed in quality;

FIG. 13 is a flowchart of a removing step of the wafer processing;

FIG. 14A is an explanatory view showing a state in which a solution film of pure water is formed on the resist pattern size shrink liquid, FIG. 14B is an explanatory view showing a state in which pure water is being supplied onto the wafer to remove an upper layer portion of the resist pattern size shrink liquid, and FIG. 14C is an explanatory view showing a state in which the wafer is rotated while a drying nozzle is being moved from above a central portion of the wafer to above an outer peripheral portion to dry the wafer;

FIG. 15 is an enlarged longitudinal sectional view of a wafer showing a state in which a solution film of pure water is formed on the resist pattern size shrink liquid;

FIG. 16 is an enlarged longitudinal sectional view of a wafer showing a state in which the upper layer portion of the resist pattern size shrink liquid has been removed;

FIG. 17A is a photograph showing defects on a resist pattern when a solution film forming step was performed, and FIG. 17B is a photograph showing defects on a resist pattern when the solution film forming step was not performed;

FIG. 18 is a table showing experimental results showing comparison of the numbers of defects on resist patterns when the humidity during the drying step was changed;

FIG. 19 is a perspective view of a cleaning nozzle having a discharge port in a slit form;

FIG. 20 is an explanatory view showing a state in which the cleaning nozzle is located above the diameter of the wafer; and

FIG. 21 is a photograph showing defects on a resist pattern when a cleaning step was performed using the cleaning nozzle in FIG. 19.

### DETAILED DESCRIPTION OF THE INVENTION

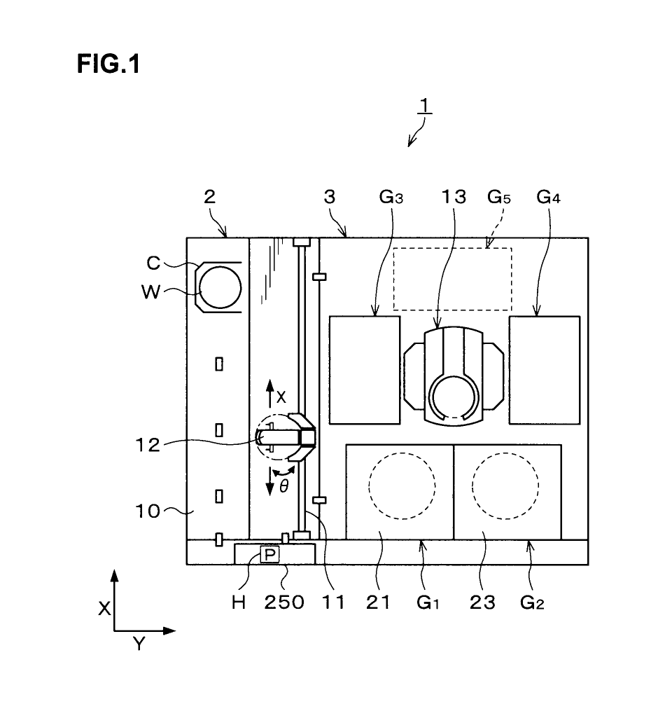

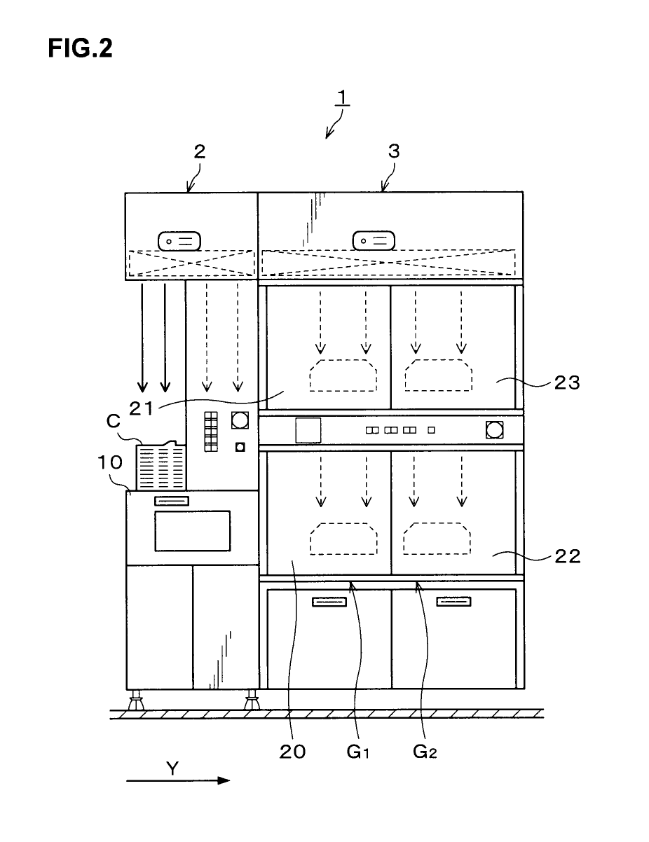

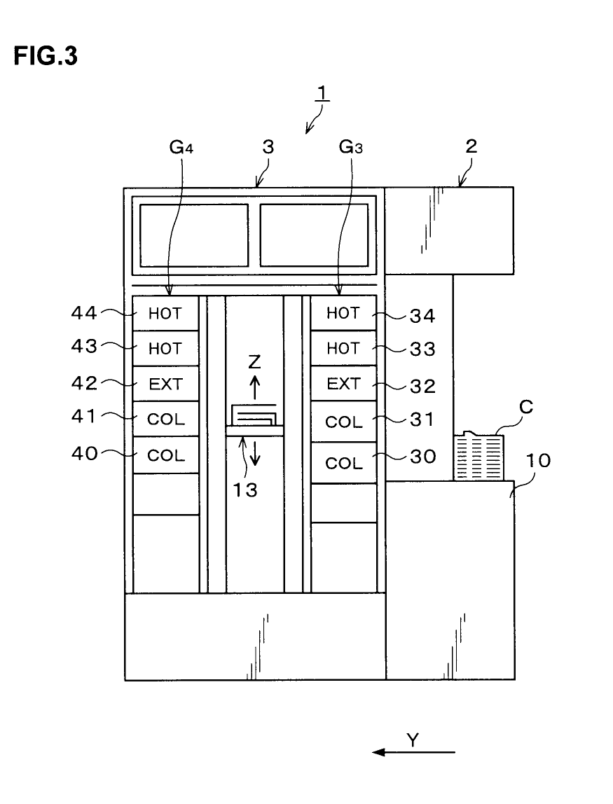

Hereinafter, a preferred embodiment of the present invention will be described. FIG. 1 is a plan view showing the outline of a configuration of a substrate processing system 1 in which a substrate processing method according to the embodiment is carried out, FIG. 2 is a front view of the substrate processing system 1, and FIG. 3 is a rear view of the substrate processing system 1.

The substrate processing system 1 has, as shown in FIG. 1, a configuration in which, for example, a cassette station 2 for transferring a plurality of wafers W per cassette as a unit from/to the outside into/from the substrate processing system 1 and transferring the wafers W into/out of a cassette C; and a processing station 3 including a plurality of processing and treatment units, which are multi-tiered, for performing various kinds of predetermined processing and treatment in a series of wafer processing are integrally connected.

In the cassette station 2, a cassette mounting table 10 is provided and configured such that a plurality of cassettes C can be mounted thereon in a line in an X-direction (a top-to-bottom direction in FIG. 1). In the cassette station 2, a wafer transfer body 12 is provided which is movable in the X-direction on a transfer path 11. The wafer transfer body 12 is also movable in a wafer-arrangement direction of the wafers W housed in the cassette C (the vertical direction), and thus can selectively access each of the wafers W in each of the cassettes C arranged in the X-direction.

The wafer transfer body 12 is rotatable in a θ-direction around the vertical axis, and can access an extension unit 32 included in a later-described third processing unit group G3 on the processing station 3 side.

At the central portion in the processing station 3, a main transfer unit 13 is provided around which various kinds of processing and treatment units are multi-tiered to constitute processing unit groups. In the substrate processing system 1, four processing unit groups G1, G2, G3, and G4 are arranged such that the first and second processing unit groups G1 and G2 are arranged on the front side of the substrate processing system 1, the processing unit group G3 is disposed on the cassette station 2 side of the main transfer unit 13, and the fourth processing unit group G4 is disposed on the opposite side to the third processing unit group G3 across the main transfer unit 13. Further, a fifth processing unit group G5 shown by a broken line as an option can be separately disposed on the rear side. The main transfer unit 13 can transfer the wafer W to each of later-described various kinds of processing and treatment units arranged in these processing unit groups G1 to G5.

In the first processing unit group G1, as shown in FIG. 2, for example, a coating unit 20 for applying a predetermined resist pattern size shrink liquid onto the wafer W, and a removing unit 21 for removing an excessive resist pattern size shrink liquid are two-tiered in order from the bottom. Similarly in the second processing unit group G2, a coating unit 22 and a removing unit 23 are two-tiered in order from the bottom.

In the third processing unit group G3, as shown in FIG. 3, for example, temperature regulating units 30 and 31 each for regulating the wafer W to a predetermined temperature, the extension unit 32 for keeping the wafer W to temporarily waiting therein, heating units 33 and 34 each as a quality-changing unit for changing the quality of the resist pattern size shrink liquid on the wafer W to insoluble to a removing solution, and the like are, for example, five-tiered in order from the bottom.

In the fourth processing unit group G4, for example, cooling processing units 40 and 41, an extension unit 42, heating units 43 and 44 and the like are, for example, five-tiered in order from the bottom.

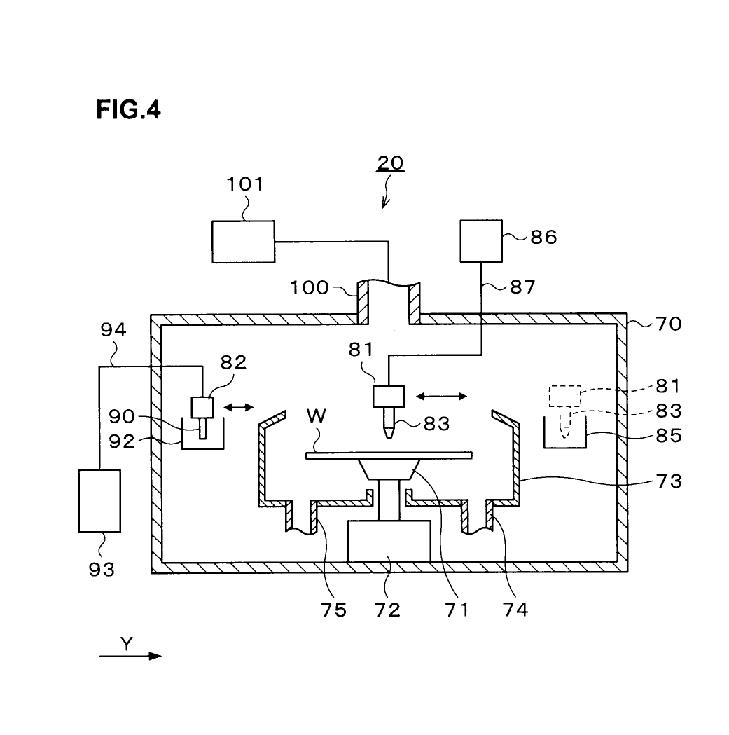

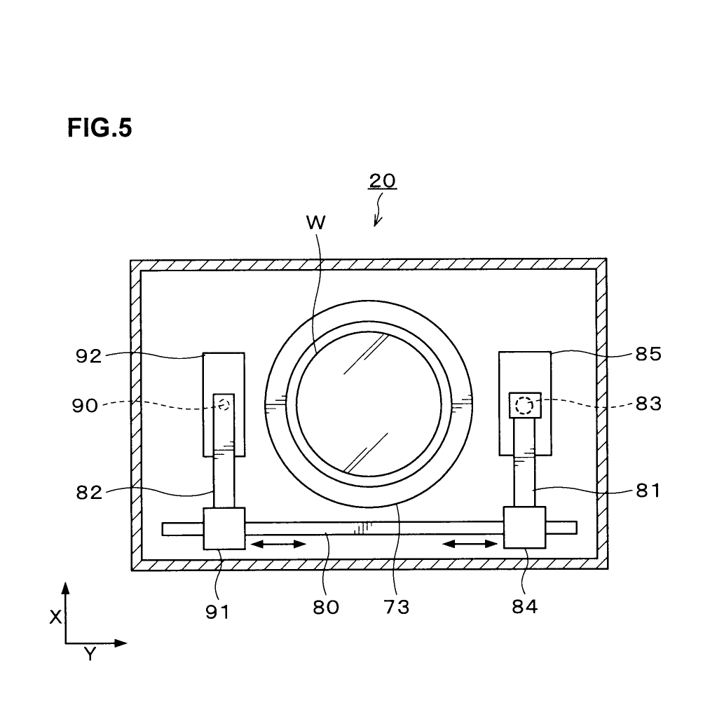

Next, the configuration of the above-described coating units 20 and 22 will be described in detail. FIG. 4 is an explanatory view of a longitudinal section showing the outline of the configuration of the coating unit 20, and FIG. 5 is an explanatory view of a transverse section of the coating unit 20.

The coating unit 20 has, for example, a casing 70 whose inside can be closed. At the central portion in the casing 70, a spin chuck 71 is provided which holds and rotates the wafer W. The spin chuck 71 has a horizontal upper surface which is provided with a suction port (not shown) for sucking the wafer W therethrough. The suction through the suction port allows the wafer W to be suction-held on the spin chuck 71.

The spin chuck 71 can rotate at a predetermined speed by means of a chuck drive mechanism 72 including a motor and the like. The chuck drive mechanism 72 is provided with a raising and lowering drive source such as a cylinder and thus can vertically move the spin chuck 71.

Around the spin chuck 71, a cup 73 is provided which receives and collects liquid splashing or dropping from the wafer W. A drain pipe 74 for draining the collected liquid and an exhaust pipe 75 for exhausting the atmosphere in the cup 73 are connected to the bottom surface of the cup 73.

As shown in FIG. 5, a rail 80 extending along the Y-direction (the right-to-left direction in FIG. 5) is formed on the side of the negative direction in the X-direction (the lower direction in FIG. 5) of the cup 73. The rail 80 is formed from the outside of the cup 73 on the side of the negative direction in the Y-direction (the left direction in FIG. 5) to the outside on the side of the positive direction in the Y-direction (the right direction in FIG. 5). To the rail 80, for example, two arms 81 and 82 are attached.

On the first arm 81, a first nozzle 83 is supported which discharges the resist pattern size shrink liquid as shown in FIG. 4 and FIG. 5. The first arm 81 can freely move on the rail 80 by means of a nozzle drive unit 84 shown in FIG. 5 and thus can move the first nozzle 83 from a waiting section 85 located outside the cup 73 on the side of the positive direction in the Y-direction to above the central portion of the wafer W in the cup 73. Further, the first arm 81 can freely rise and lower by means of the nozzle drive unit 84 to adjust the height of the first nozzle 83.

To the first nozzle 83, a supply pipe 87 is connected which leads to a size shrink liquid supply source 86 as shown in FIG. 4. In this embodiment, for example, a resist pattern size shrink liquid (RELACS agent) that is water-soluble and reacts with the resist by heat to change in quality to insoluble to pure water as a removing solution, and gets a resistance to the etching material after the change in quality is stored in the size shrink liquid supply source 86. Specifically, for example, RELACS R602 (AZ Electronic Materials Co.) is used for the resist pattern size shrink liquid.

On the second arm 82, a second nozzle 90 is supported which discharges pure water. The second arm 82 can freely move on the rail 80 by means of a nozzle drive unit 91 shown in FIG. 5 and thus can move the second nozzle 90 from a waiting section 92 located outside the cup 73 on the side of the negative direction in the Y-direction to above the central portion of the wafer W in the cup 73. Further, the second arm 82 can freely rise and lower by means of the nozzle drive unit 91 to adjust the height of the second nozzle 90.

To the second nozzle 90, a supply pipe 94 is connected which leads to a pure water supply source 93 as shown in FIG. 4.

A gas supply pipe 100 is connected, for example, to the central portion of the ceiling surface of the casing 70. To the gas supply pipe 100, a temperature and humidity regulating unit 101 is connected. The temperature and humidity regulating unit 101 can be used to supply gas whose temperature and humidity are regulated into the casing 70, thereby regulating the inside of the casing 70 to an atmosphere at a predetermined temperature and humidity.

Note that the configuration of the coating unit 22 is the same as that of the above-described coating unit 20 and therefore its explanation will be omitted.

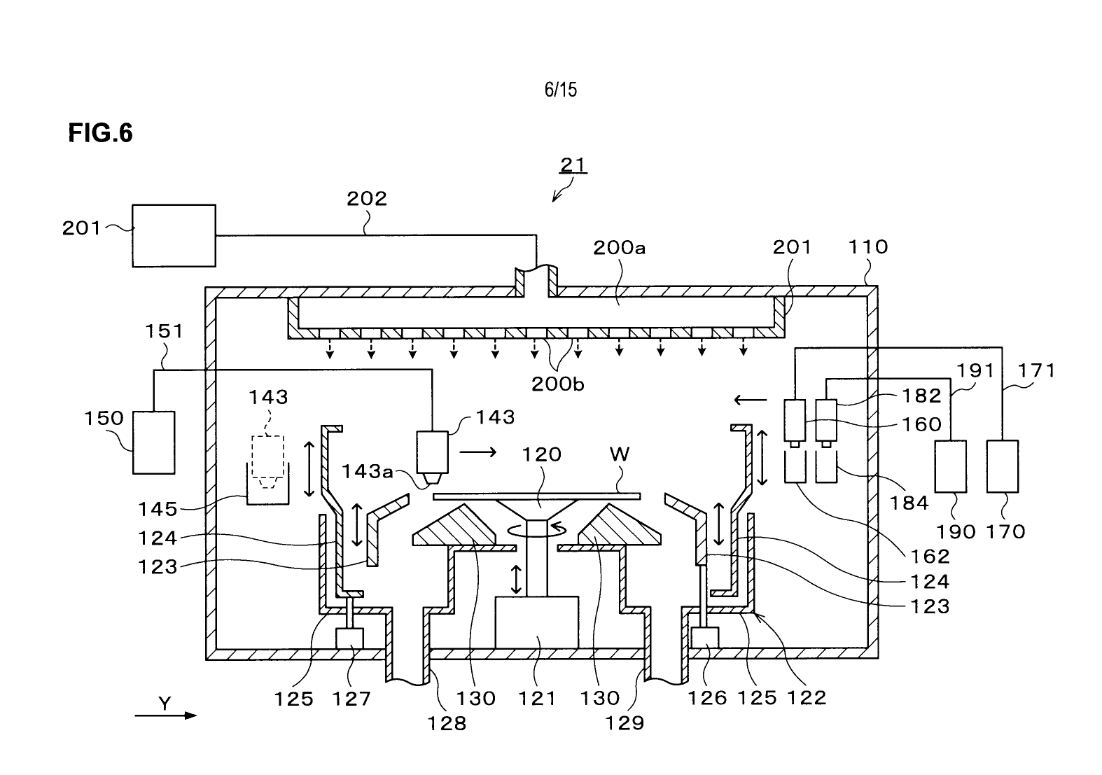

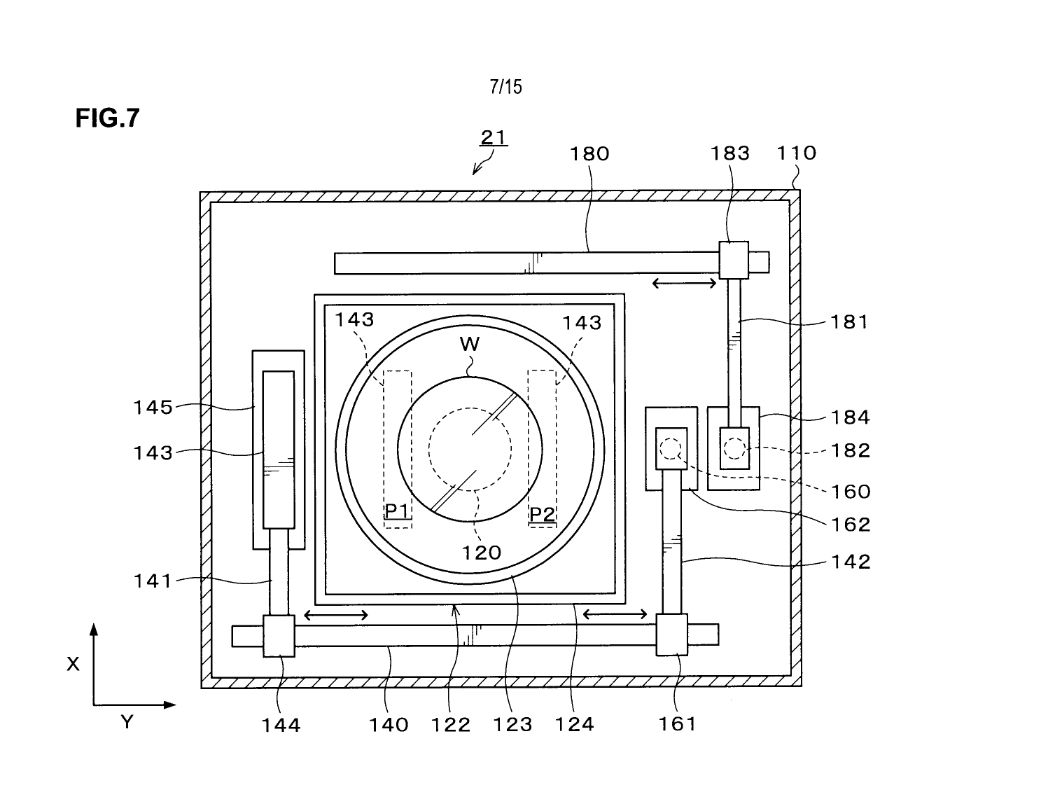

Next, the configuration of the removing units 21 and 23 will be described. FIG. 6 is an explanatory view of a longitudinal section showing the outline of the configuration of the removing unit 21, and FIG. 7 is an explanatory view of a transverse section showing the outline of the configuration of the removing unit 21.

The removing unit 21 has, for example, a casing 110 whose inside can be closed as shown in FIG. 6. At the central portion in the casing 110, a spin chuck 120 is provided as a rotary holding member which holds and rotates the wafer W. The spin chuck 120 has a horizontal upper surface which is provided with a suction port (not shown) for sucking the wafer W therethrough. The suction through the suction port allows the wafer W to be suction-held on the spin chuck 120.

The spin chuck 120 can rotate at a predetermined speed by means of a chuck drive mechanism 121 including a motor and the like. The chuck drive mechanism 121 is provided with a raising and lowering drive source such as a cylinder and thus can vertically move the spin chuck 120.

Around the spin chuck 120, a cup 122 is provided which receives and collects liquid splashing or dropping from the wafer W. The cup 122 includes separately an inner cup 123 surrounding the periphery of the spin chuck 120, an outer cup 124 surrounding the outer periphery of the inner cup 123, and a lower cup 125 covering the lower surface of the inner cup 123 and the outer cup 124. The inner cup 123 and the outer cup 124 can mainly receive the liquid splashing toward the outside of the wafer W, and the lower cup 125 can collect the liquid dropping down from the inner walls of the inner cup 123 and the outer cup 124 and from the wafer W.

The inner cup 123 is formed, for example, in an almost cylindrical shape with its upper end portion inclined inward and upward. The inner cup 123 can vertically move by means of a raising and lowering drive unit 126 such as a cylinder or the like. The outer cup 124 is formed, for example, in an almost cylindrical shape that is rectangular as seen in plan view as shown in FIG. 7. The outer cup 124 can vertically move by means of a raising and lowering drive unit 127 such as a cylinder or the like as shown in FIG. 6. To the lower cup 125, a drain pipe 128 for draining the collected liquid, and an exhaust pipe 129 for exhausting the atmosphere in the cup 122 are connected.

Around the spin chuck 120, for example, an annular member 130 is provided. The annular member 130 includes a top portion approaching to the rear surface of the wafer W so that the top portion can block the liquid flowing down the rear surface of the wafer W.

On the side of the negative direction in the X-direction (the lower direction in FIG. 7) of the cup 122, a rail 140 is formed extending along the Y-direction (the right-to-left direction in FIG. 7). The rail 140 is formed from the outside of the cup 122 on the side of the negative direction in the Y-direction (the left direction in FIG. 7) to the outside of the cup 122 on the side of the positive direction in the Y-direction (the right direction in FIG. 7). To the rail 140, for example, two arms 141 and 142 are attached.

On the first arm 141, as shown in FIG. 7, a solution film forming nozzle 143 is supported for discharging a removing solution onto the wafer to form a solution film of the removing solution. The first arm 141 can freely move on the rail 140 by means of a nozzle drive unit 144 and thus can move the solution film forming nozzle 143 from a waiting section 145 located outside the cup 122 on the side of the negative direction in the Y-direction to above the wafer W in the cup 122 and move it above the front surface of the wafer W. Further, the first arm 141 can freely rise and lower by means of the nozzle drive unit 144 to adjust the height of the solution film forming nozzle 143.

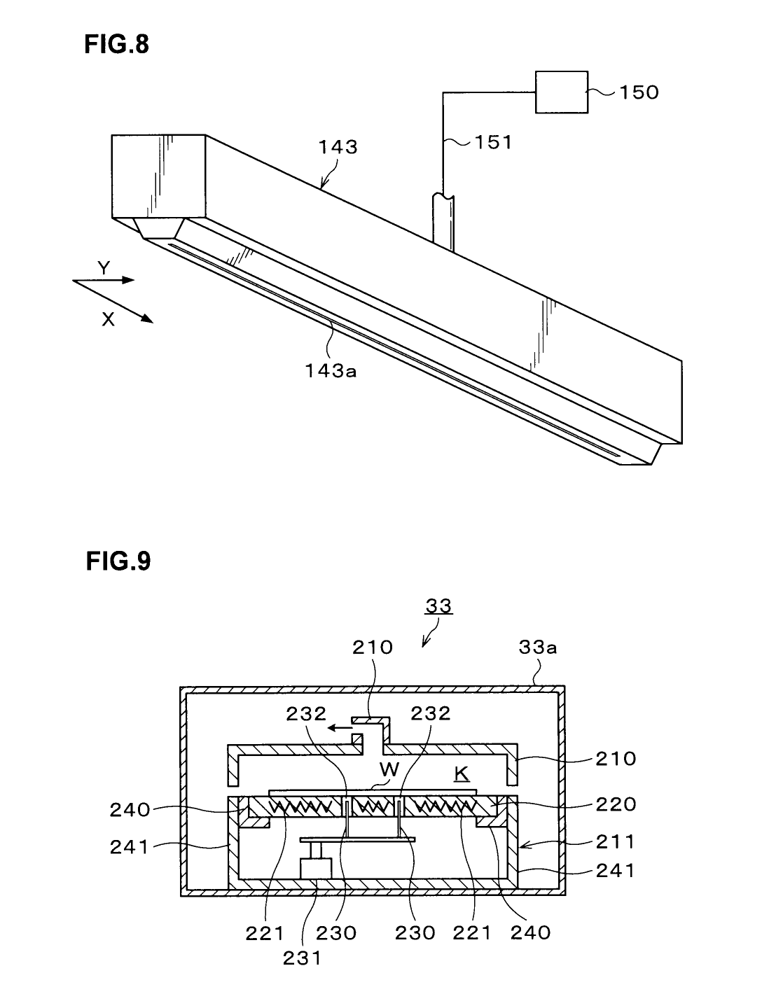

The solution film forming nozzle 143 has, for example, an elongated shape that is long along the X-direction as shown in FIG. 8. To the upper portion of the solution film forming nozzle 143, a supply pipe 151 is connected which leads to a removing solution supply source 150. In a lower portion of the solution film forming nozzle 143, a discharge port 143a in a slit form which is equal to or longer than the diameter size of the wafer W is formed along the longitudinal direction. The solution film forming nozzle 143 can pass the removing solution introduced from the supply pipe 151 provided at the upper portion through the inside of the solution film forming nozzle 143, and uniformly discharge it from the discharge port 143a in the lower portion. Note that, for example, pure water is stored as the removing solution in the removing solution supply source 150 in this embodiment.

On the second arm 142, a cleaning nozzle 160 is supported for discharging a removing solution onto the center of the wafer W to clean the wafer W as shown in FIG. 7. The second arm 142 can freely move on the rail 140 by means of a nozzle drive unit 161 and thus can move the cleaning nozzle 160 from a waiting section 162 located outside the cup 122 on the side of the positive direction in the Y-direction to above the central portion of the wafer W in the cup 122. Further, the second arm 142 can freely rise and lower by means of the nozzle drive unit 161 to adjust the height of the cleaning nozzle 160.

The cleaning nozzle 160 is formed in an almost cylindrical shape and can discharge the removing solution downward as shown in FIG. 6. To the cleaning nozzle 160, a supply pipe 171 is connected which leads to a removing solution supply source 170. In this embodiment, for example, pure water is stored in the removing solution supply source 170.

On the side of the positive direction in the X-direction (the upper direction in FIG. 7) of the cup 122, a rail 180 is formed extending along the Y-direction as shown in FIG. 7. The rail 180 is formed from the outside of the cup 122 on the side of the positive direction in the Y-direction to the outside of the cup 122 on the side of the negative direction in the Y-direction. To the rail 180, for example, a third arm 181 is attached. On the third arm 181, a drying nozzle 182 is supported which discharges a removing solution during the drying of the wafer W. The third arm 181 can freely move on the rail 180 by means of a nozzle drive unit 183 shown in FIG. 7 and thus can move the drying nozzle 182 from a waiting section 184 located outside the cup 122 on the side of the positive direction in the Y-direction to above the wafer W in the cup 122 and move it above the front surface of the wafer W. Further, the third arm 181 can freely rise and lower by means of the nozzle drive unit 183 to adjust the height of the drying nozzle 182.

The drying nozzle 182 is formed in an almost cylindrical shape and can discharge the removing solution downward as shown in FIG. 6. To the drying nozzle 182, a supply pipe 191 is connected which leads to a removing solution supply source 190. In this embodiment, for example, pure water is stored in the removing solution supply source 190.

For example, on the ceiling surface of the casing 110, a gas supply unit 200 is provided which supplies into the casing 110 a gas whose temperature and humidity are adjusted. The gas supply unit 200 has, for example, a gas flow-in chamber 200a and a number of gas supply holes 200b provided in its lower surface and can supply the gas downward to the entire inside of the casing 110. To the gas supply unit 200, a temperature and humidity regulating unit 201 for regulating the temperature and the humidity of a gas and supplying the gas to the gas supply unit 200 is connected via a gas supply pipe 202. In this embodiment, for example, the gas supply unit 200, the temperature and humidity regulating unit 201, and the gas supply pipe 202 constitute a humidity regulating unit.

Note that the configuration of the removing unit 23 is the same as that of the above-described removing unit 21 and therefore its explanation will be omitted.

Next, the configuration of the above-described heating units 33, 34, 43, and 44 will be described. For example, the heating unit 33 has a lid body 210 which is located on the upper side and vertically movable, and a thermal plate accommodating unit 211 which is located on the lower side and forms a treatment chamber K together with the lid body 210 in a casing 33a as shown in FIG. 9.

The lid body 210 has an almost cylindrical shape with its lower surface open. At the central portion of the upper surface of the lid body 210, an exhaust portion 210a is provided. The atmosphere in the treatment chamber K can be uniformly exhausted through the exhaust portion 210a.

At the central portion of the thermal plate accommodating unit 211, a thermal plate 220 is provided. The thermal plate 220 is formed, for example, in an almost disk shape. Inside the thermal plate 220, a heater 221 which generates heat by power feed is embedded and can heat the thermal plate 220 to a predetermined temperature.

For example, under the thermal plate 220, raising and lowering pins 230 are provided for supporting and raising and lowering the wafer W from below. The raising and lowering pins 230 can vertically move by means of a raising and lowering drive mechanism 231. Near the central portion of the thermal plate 220, through holes 232 are formed which penetrate the thermal plate 220 in the thickness direction, so that the raising and lowering pins 230 can rise from below the thermal plate 220 and pass through the through holes 232 to protrude to above the thermal plate 220.

The thermal plate accommodating unit 211 includes an annular supporting member 240 for accommodating the thermal plate 220 and supporting the outer peripheral portion of the thermal plate 220, and a support ring 241 in an almost cylindrical shape surrounding the outer periphery of the support member 240.

The configurations of the heating units 34, 43, and 44 are the same as that of the above-described heating unit 33 and thus explanation thereof will be omitted.

The wafer processing performed in the above-described substrate processing system 1 is controlled by a control unit 250 provided, for example, in the cassette station 2 as shown in FIG. 1. The control unit 250 is, for example, a computer which has a program storage unit. The program storage unit stores, for example, a program P which controls the operation of the above-described various kinds of processing and treatment units and wafer transfer units to execute the wafer processing of a later-described predetermined recipe. The program P is stored, for example, in a computer-readable storage medium H and installed from the storage medium into the control unit 250 for use.

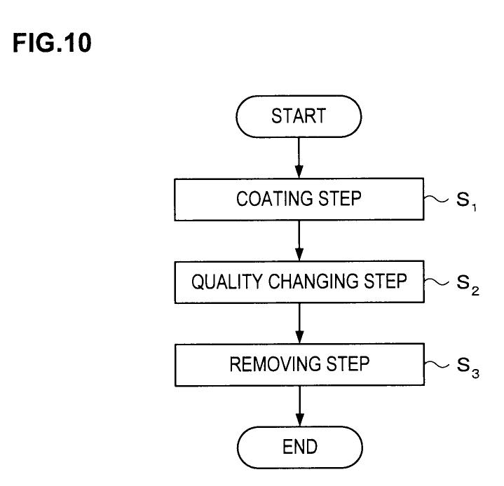

Next, the wafer processing performed in the substrate processing system 1 configured as described above will be described. FIG. 10 is a flowchart showing main steps of the wafer processing.

In the substrate processing system 1, wafers W on which a resist pattern has been previously formed in the photolithography process will be processed. First of all, a plurality of wafers W having a resist pattern formed thereon have been housed in the cassette C in advance, and the cassette C is mounted on the cassette mounting table 10 in the substrate processing system 1. The wafer W in the cassette C is taken out by the wafer transfer body 12 and transferred to the extension unit 32 in the third processing unit group G3. The wafer W is then transferred by the main transfer unit 13, for example, to the temperature regulating unit 30, where it is regulated to a predetermined temperature, and thereafter transferred to the coating unit 20.

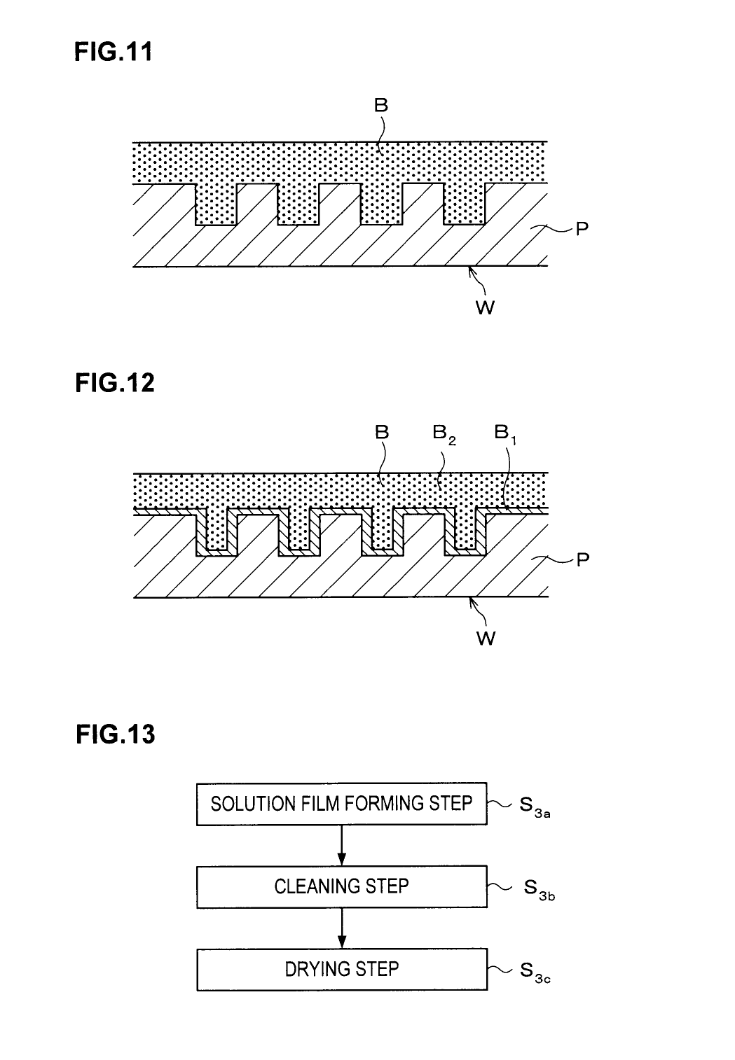

After transferred into the coating unit 20, the wafer W is suction-held on the spin chuck 71 as shown in FIG. 4. Subsequently, the second nozzle 90 is moved to above the central portion of the wafer W and supplies a predetermined amount of pure water to the central portion of the wafer W. The wafer W is then rotated so that the pure water on the wafer W is spread by the centrifugal force. The pure water in this event is not spread over the entire front surface of the wafer W but spread into a circular puddle near the central portion of the wafer W. Next, the first nozzle 83 is moved to above the central portion of the wafer W, and supplies a predetermined amount of resist pattern size shrink liquid onto the pure water at the central portion of the wafer W. Thereafter, the rotation speed of the wafer W is increased to spread the resist pattern size shrink liquid over the entire front surface of the wafer W. Thus, the resist pattern size shrink liquid B is applied on the irregular front surface of the resist pattern P on the wafer W as shown in FIG. 11 (coating step S1 shown in FIG. 10).

Next, the rotation speed of the wafer W is adjusted, whereby the resist pattern size shrink liquid B is adjusted to a predetermined film thickness. The rotation speed of the wafer W is then increased to dry the resist pattern size shrink liquid B. Thus, a series of coating treatment ends.

After completion of the coating treatment, the wafer W is transferred, for example, by the main transfer unit 13 to the heating unit 33 shown in FIG. 9. After transferred into the heating unit 33, the wafer W is passed to the raising and lowering pins 230 which have been raised and waiting in advance, and the raising and lowering pins 230 are lowered to mount the wafer W onto the thermal plate 220. Thus, the wafer W is heated by the thermal plate 220. This heating hardens the resist pattern size shrink liquid B, and a lower layer portion B1 of the resist pattern size shrink liquid B closer to the irregular surface of the resist pattern P chemically reacts with the resist pattern P as shown in FIG. 12, so that the lower layer portion B1 changes in quality to insoluble to the pure water as the removing solution (quality changing step S2 in FIG. 10). Note that an upper portion B2 of the resist pattern size shrink liquid B still keeps its water-solubility. After a lapse of a predetermined time, the raising and lowering pins 230 are raised again, with which the heating of the wafer W ends.

After completion of the heating processing, the wafer W is transferred by the main transfer unit 13, for example, to the cooling processing unit 40 so that its temperature is returned to room temperature, and then transferred into the removing unit 21 shown in FIG. 6. In this event, clean air that is a gas having a humidity of 40% or less at room temperature, for example, 23° C. is being supplied from the gas supply unit 200 into the removing unit 21, so that the relative humidity of the entire inside of the casing 110 is kept at 40% or less.

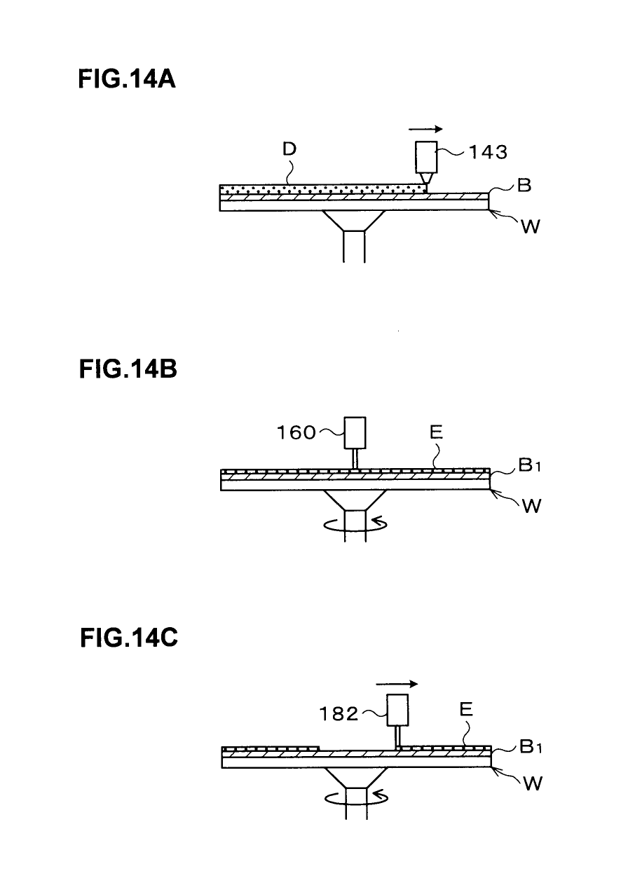

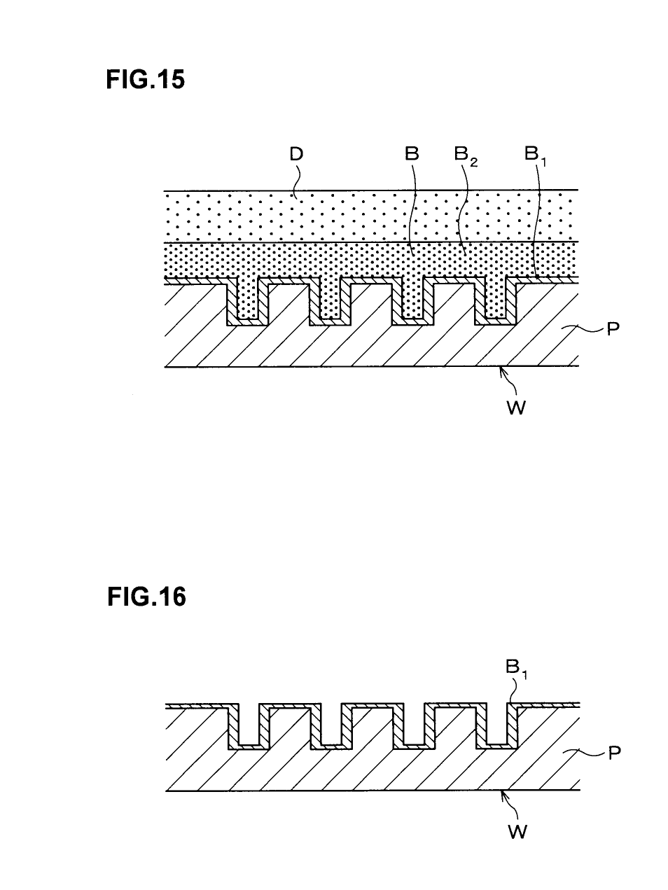

FIG. 13 is a flowchart of the removing step S3 to be performed in the removing unit 21. Once the wafer W is transferred into the removing unit 21, it is held on the spin chuck 120. Subsequently, the solution film forming nozzle 143 is moved to a start position P1 (shown in FIG. 7) on one end portion of the wafer W. The solution film forming nozzle 143 then begins to discharge pure water. Thereafter, the solution film forming nozzle 143 is moved from the start position P1 on the one end portion of the wafer W, passing above the front surface of the wafer W to an end position P2 (shown in FIG. 7) on the other end portion of the wafer W, while discharging the pure water from the discharge port 143a with the wafer W at rest as shown in FIG. 14A. Thus, a solution film D of the pure water is formed on the resist pattern size shrink liquid B as shown in FIG. 15. This allows the upper layer portion B2 which has not changed in quality of the resist pattern size shrink liquid B dissolves in the solution film D (solution film forming step S3a in FIG. 13).

The solution film forming nozzle 143 is then returned to the waiting section 145, and the cleaning nozzle 160 is subsequently moved to above the central portion of the wafer W. The wafer W is then rotated, for example, at a speed of about 800 rpm as shown in FIG. 14B, and the cleaning nozzle 160 supplies a pure water E to the central portion of the wafer W. This removes the upper layer portion B2 of the resist pattern size shrink liquid B from above the wafer W to thereby clean the wafer W (cleaning step S3b in FIG. 13).

After the wafer W is cleaned for a predetermined time, the cleaning nozzle 160 is returned to the waiting section 162, and the drying nozzle 182 is subsequently moved to above the central portion of the wafer W. Thereafter, the rotation speed of the wafer W is increased, for example, to about 2000 rpm as shown inn FIG. 14C. In this event, the drying nozzle 182 is moved from above the central portion of the wafer W to above the outer peripheral portion while discharging the pure water. This removes moisture from the front surface of the wafer W to thereby dry the wafer W (drying step S3c in FIG. 13).

Thus, the lower layer portion B1 of the resist pattern size shrink liquid B is left on the inner wall surface of the recesses of the resist pattern P as shown in FIG. 16, whereby the resist pattern P is shrunk in size.

After completion of the removing step, the wafer W is returned, for example, by the main transfer unit 13 and the wafer transfer body 12 from the processing station 3 into the cassette C in the cassette station 2. Thus a series of wafer processing ends.

According to the above embodiment, since the solution film D of pure water is formed on the wafer W in the removing step S3 for the resist pattern size shrink liquid B, the shock to the resist pattern size shrink liquid B by the pure water at the supply of the pure water can be lessened to reduce damage to the lower layer portion B2 of the resist pattern size shrink liquid B. This can reduce defects on the finally formed resist pattern P. The results of the experiment demonstrating the effectiveness when the solution film D of pure water is formed in the removing step S3 are shown here.

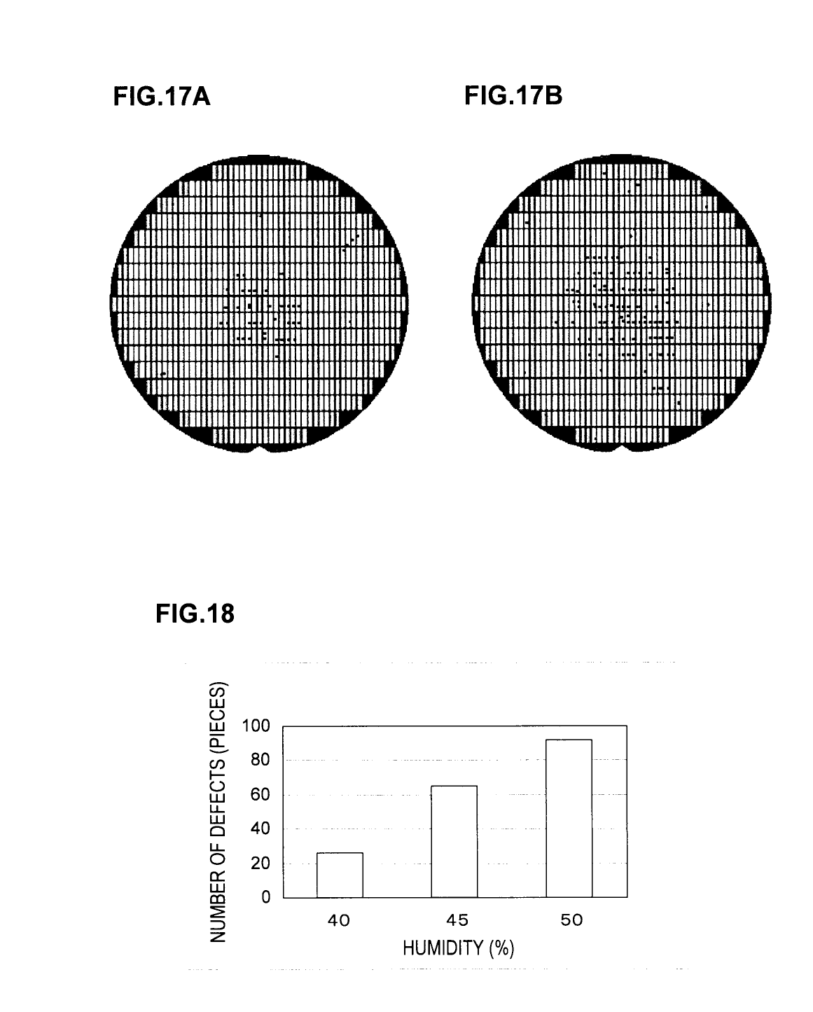

FIG. 17A is a photograph taking the final resist pattern on the wafer W when the solution film forming step S3a was performed in the removing step S3. FIG. 17B is a photograph taking the final resist pattern on the wafer W when the removing step S3 was performed starting from the cleaning step S3b without performing the solution film forming step S3a. Black spots in FIGS. 17A and 17B show defects. When the solution film forming step S3a was performed, the number of defects was 65 in FIG. 17A. When the solution film forming step S3a was not performed, the number of defects was 319 in FIG. 17B. Thus, it can be verified from this experiment that the defects on the resist pattern are significantly reduced when the solution film forming step S3a was performed.

In the above embodiment, in the solution film forming step S3a of the removing step S3, the solution film forming nozzle 143 is moved from above the one end portion of the wafer W to above the other end portion while discharging the pure water to form the solution film D of the pure water with the wafer W at rest, so that the shock to the wafer W by the pure water can be extremely lessened. This further reduces the damage to the lower layer portion B2 of the resist pattern size shrink liquid B.

In the above embodiment, in the cleaning step S3b of the removing step S3, the pure water is supplied from the cleaning nozzle 160 to the central portion of the rotated wafer W, so that the cleaning of the wafer W can be quickly performed.

Further, since the drying nozzle 182 is moved from above the central portion of the wafer W to above the outer peripheral portion while discharging pure water with the wafer W being rotated in the drying step S3c of the removing step S3, the drying takes place in one direction from the central portion of the wafer W toward the outer peripheral portion, so that the drying of the front surface of the wafer W is quickly performed without unevenness. Note that it is not always necessary to use the drying nozzle 182 in the drying step S3c, but the wafer W may be simply rotated at a high speed to be dried.

In the above embodiment, the humidity of the atmosphere around the wafer W is kept at 40% or less during the drying step S3c, thereby allowing the drying of the front surface of the wafer W to be quickly performed. This can also reduce the defects on the resist pattern P to be finally formed. FIG. 18 is the experimental results showing comparison of the numbers of defects on the final resist patterns when the humidity of the atmosphere around the wafer W during the drying step S3c was changed. In this experiment, the humidity of the atmosphere around the wafer W during the drying step S3c was changed to 50%, 45%, and 40% and the numbers of defects were checked. Table in FIG. 18 shows that the number of defects decreases with a reduction in humidity of the atmosphere around the wafer W, and that when the humidity is set to 40%, the number is less than 30 that is the target value. Accordingly, it can be found that the defects on the resist pattern P can be sufficiently reduced by setting the relative humidity of the atmosphere around the wafer W to 40% or less during the drying step S3c.

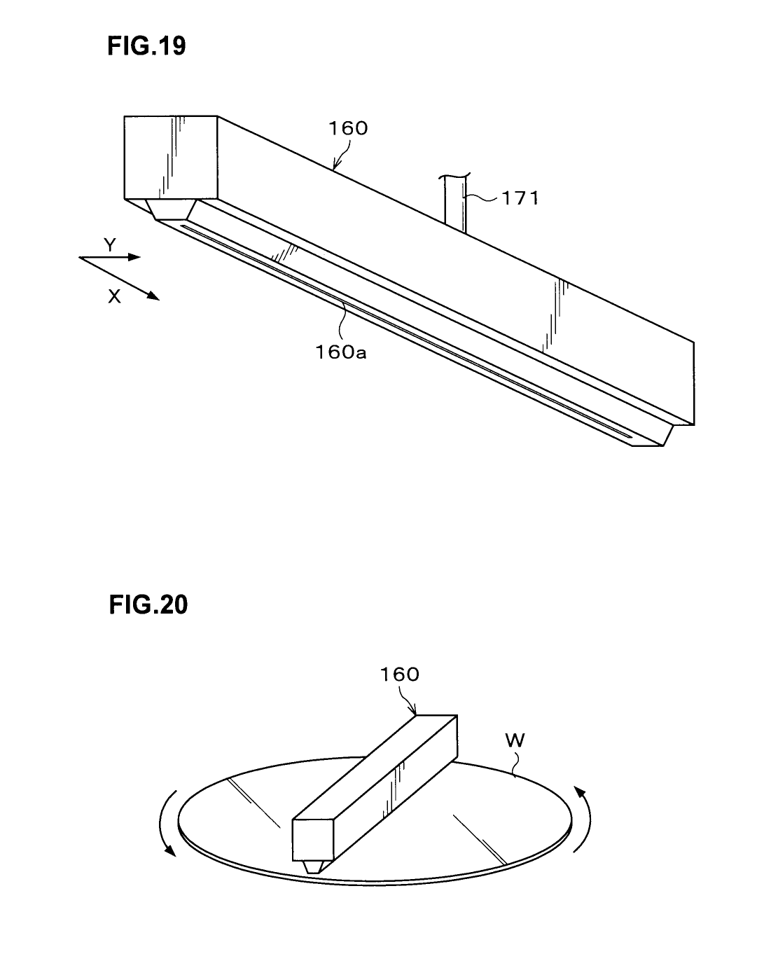

Although the cleaning nozzle 160 is formed in an almost cylindrical shape and supplies pure water only to the central portion of the wafer W in the cleaning step S3b of the removing step S3 in the above embodiment, the cleaning nozzle 160 may have an almost parallelepiped shape as shown in FIG. 19 similarly to the solution film forming nozzle 143 and include at its lower surface a discharge port 160a in a slit form equal to or longer than the diameter of the wafer W. During the cleaning step S3b of the removing step S3, the cleaning nozzle 160 is moved above the diameter of the wafer W as shown in FIG. 20. The wafer W is then rotated, for example, at a low speed of about 100 rpm, and pure water is supplied from the discharge port 160a of the cleaning nozzle 160 onto the diameter of the wafer W.

This removes the upper layer portion B2 of the resist pattern size shrink liquid B together with the pure water from the top of the wafer W to thereby clean the wafer W. In this case, the shock to the wafer W by the pure water at the supply of the pure water is mitigated as compared to the above-described cleaning nozzle in an almost cylindrical shape also in the cleaning step S3b, so that the damage to the lower layer portion B2 of the resist pattern size shrink liquid B is further decreased to reduce the defects on the resist pattern P.

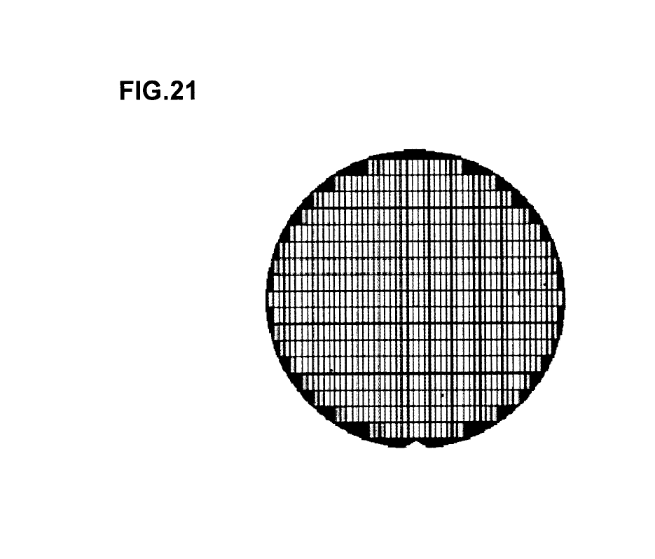

FIG. 21 is a photograph of an experiment taking a final resist pattern on the wafer W when the cleaning nozzle 160 in FIG. 19 was used in the cleaning step S3b. The number of defects on the resist pattern when the cleaning nozzle 160 in FIG. 19 was not used was 65 (shown in FIG. 17B), whereas the number of defects when the cleaning nozzle 160 in FIG. 19 was used was 5. Thus, it can be found from this experiment that the number of defects on the resist pattern was further reduced when the cleaning nozzle 160 in FIG. 19 was used in the cleaning step S3b.

A preferred embodiment of the present invention has been described above with reference to the accompanying drawings, but the present invention is not limited to the embodiment. It should be understood that various changes and modifications within the scope of the spirit as set forth in claims are readily apparent to those skilled in the art, and those should also be covered by the technical scope of the present invention.

For example, though only the wafer processing of shrinking the size of the resist pattern is performed in the substrate processing system 1 in the above embodiment, the photolithography process of forming the resist pattern may also be performed. In this case, a resist coating treatment unit for applying a resist solution to the wafer W to form a resist film, a developing treatment unit for developing the resist film on the wafer W and so on may be provided in the processing station 3 in the substrate processing system 1, and an aligner for exposing the resist film to light may be provided adjacent to the processing station 3.

Although the lower layer portion B1 of the resist pattern size shrink liquid B is changed in quality by heating it after coating treatment in the above embodiment, it may be changed in quality by light. Besides, though the pure water is used as the removing solution in the above embodiment, other liquid may be used.

The present invention is also applicable, for example, to substrate processing when shrinking the size of the resist pattern formed on an FPD (Flat Panel Display), a mask reticle for a photomask, or the like other than the wafer W.

The present invention is useful for reducing defects on a resist pattern to be finally formed when using RELACS technology to shrink the size of the resist pattern.

What is claimed is:

1. A substrate processing method for shrinking a size of a resist pattern formed on a substrate, comprising:
a coating step of applying a resist pattern size shrink liquid soluble to a removing solution onto the resist pattern of the substrate;
thereafter, a quality-changing step of changing in quality a lower layer portion of the resist pattern size shrink liquid in contact with a front surface of the resist pattern to insoluble to the removing solution; and
thereafter, a removing step of removing an upper layer portion which has not changed in quality of the resist pattern size shrink liquid with the removing solution,
said removing step including:
a first step of forming a solution film of a removing solution on the substrate with the substrate at rest to dissolve the upper layer portion of the resist pattern size shrink liquid by the solution film of the removing solution; thereafter, a second step of supplying a removing solution to the substrate with the substrate being rotated to remove the upper layer portion of the resist pattern size shrink liquid from a top of the substrate; and thereafter, a third step of drying the substrate.

2. The substrate processing method as set forth in claim 1,
wherein said first step is performed by a solution film forming nozzle moving from above one end portion of the substrate to above another end portion while discharging the removing solution, said solution film forming nozzle having a discharge port equal to or longer than a diameter of the substrate.

3. The substrate processing method as set forth in claim 1,
wherein said second step is performed by a cleaning nozzle discharging the removing solution to a central portion of the rotated substrate.

4. The substrate processing method as set forth in claim 1,
wherein said second step is performed by a cleaning nozzle being located above a diameter of the rotated substrate and discharging the removing solution onto the diameter of the substrate, said cleaning nozzle having a discharge port equal to or longer than the diameter of the substrate.

5. The substrate processing method as set forth in claim 1,
wherein said third step is performed by a drying nozzle moving from above a central portion of the substrate to above an outer peripheral portion while discharging a removing solution with the substrate being rotated.

6. The substrate processing method as set forth in claim 1,
wherein in said third step, a relative humidity of an atmosphere around the substrate is kept at 40% or less.

7. A substrate processing system for shrinking a size of a resist pattern formed on a substrate, comprising:
a coating unit applying a resist pattern size shrink liquid soluble to a removing solution onto the resist pattern of the substrate;
a quality-changing unit changing in quality a lower layer portion of the resist pattern size shrink liquid in contact with a front surface of the resist pattern to insoluble to the removing solution; and
a removing unit removing an upper layer portion which has not changed in quality of the resist pattern size shrink liquid with the removing solution,
said removing unit including:
a rotary holding member capable of holding and rotating the substrate; a solution film forming nozzle supplying a removing solution onto the substrate at rest to form a solution film of the removing solution on the substrate to thereby dissolve the upper layer portion of the resist pattern size shrink liquid by the solution film of the removing solution; and a cleaning nozzle supplying a removing solution to the rotated substrate to remove the upper layer portion of the resist pattern size shrink liquid on the substrate from a top of the substrate.

8. The substrate processing system as set forth in claim 7,
wherein said solution film forming nozzle has a discharge port equal to or longer than a diameter of the substrate and is movable from above one end portion of the substrate to above another end portion while discharging the removing solution.

9. The substrate processing system as set forth in claim 7,
wherein said cleaning nozzle is capable of discharging the removing solution to a central portion of the substrate.

10. The substrate processing system as set forth in claim 7,
wherein said cleaning nozzle has a discharge port equal to or longer than a diameter of the substrate and is capable of discharging the removing solution onto the diameter of the substrate while being located above the diameter of the substrate.

11. The substrate processing system as set forth in claim 7, further comprising:
a drying nozzle supplying a removing solution to the substrate when the substrate is rotated to be dried,
said drying nozzle being movable from above a central portion of the substrate to above an outer peripheral portion while discharging the removing solution.

12. The substrate processing system as set forth in claim 7,
wherein said removing unit has a humidity regulating unit regulating a relative humidity of an atmosphere around the substrate held on said rotary holding member to 40% or less.

13. A computer-readable storage medium storing a program running on a computer of a control unit controlling a substrate processing system to execute a substrate processing method by the substrate processing system,
wherein said substrate processing method is a substrate processing method for shrinking a size of a resist pattern formed on a substrate, and comprises: a coating step of applying a resist pattern size shrink liquid soluble to a removing solution onto the resist pattern of the substrate; thereafter, a quality-changing step of changing in quality a lower layer portion of the resist pattern size shrink liquid in contact with a front surface of the resist pattern to insoluble to the removing solution; and thereafter, a removing step of removing an upper layer portion which has not changed in quality of the resist pattern size shrink liquid with the removing solution,
said removing step including:
a first step of forming a solution film of a removing solution on the substrate with the substrate at rest to dissolve the upper layer portion of the resist pattern size shrink liquid by the solution film of the removing solution; thereafter, a second step of supplying a removing solution to the substrate with the substrate being rotated to remove the upper layer portion of the resist pattern size shrink liquid from a top of the substrate; and thereafter, a third step of drying the substrate.
